(19) United States
(12) Patent Application Publication
(10) Pub. No.: US 2005/0252080 A1
(43) Pub. Date: Nov. 17, 2005

(54) System and method for promoting growth of multiple root systems in a hydroponic environment

(76) Inventor: Paul L. Wright, Tucson, AZ (US)

Correspondence Address: CESARI AND MCKENNA, LLP, 88 BLACK FALCON AVENUE, BOSTON, MA, 02210, US

(21) Appl. No.: 10/845,973

(22) Filed: May 14, 2004

(51) Int. Cl. A01G 9/02

(52) U.S. Cl. 47/79

(57) ABSTRACT

This invention provides a container and associated growing process that promotes the growth of at least two different, specialized types of roots and that provides the optimal conditions for these two types of roots. In particular, the container defines an upper section that promotes growth of a fine intricate web of roots that is surrounded by an organic, non-organic or mixed organic and non-organic nutrient-rich medium. This upper section is separated by a permeable medium divider that allows predetermined quantities of water to pass into the upper section (to maintain desired moisture in the nutrient medium (soil), while a lower/bottom section contains a reservoir of hydroponic water that may be relatively free of any nutrients (e.g. “non-nutrient” water). Extending from the upper root ball are a series of water-drinking straw-like roots that transpire water directly from the non-nutrient reservoir and that are continually exposed to massive amounts of atmospheric oxygen. A transport (capillary) device allows water to wick from the reservoir into the upper section to maintain a desired level of moisture in the upper roots, and carrying with it additional dissolved oxygen via evaporation and transpiration. The bottom section can be filled with an acceptable porous, water-storing medium such as gravel or rock wool. The permeable medium divider can include one or more capillary devices that allow transfer of water from the lower reservoir into the upper section. In certain embodiments, the divider can include a series of formations that allow it to sit in an elevated manner on a water-containing structure (such as a sponge-like medium).

### BACKGROUND OF THE INVENTION

1. Field of the Invention

This invention relates to hydroponics and, in particular, to the promotion of root growth in containers having a nutrient layer and a non-nutrient water layer.

2. Background Information

The field of hydroponics relates to the increase of root exposure in plants to the surrounding atmosphere to increase resulting uptake of oxygen. By increasing root exposure to oxygen, the metabolism of the plant is increased. It follows that a faster metabolism allows the application of nutrients to the plant to be increased and this, in turn, facilitates more rapid plant growth and production. In particular, hydroponic growth entails the application of water or moisture to the plant with its roots placed in a medium that allows them to be exposed to a large amount of air, while the roots concurrently remain sufficiently moist to remain viable and healthy.

In a conventional hydroponic arrangement, a plant is suspended in a container, and its roots extend downwardly into a hydroponic medium to absorb needed water. In certain techniques, the roots are surrounded by a medium such as perlite, lava rock (pea gravel) or rock wool, and water is applied periodically (for 30 minutes each six hours, for example) in a “ebb and flow” manner. The roots remain moist between flooding through contact with the water-absorbing medium. Alternatively, water can be applied in a thin film at the base of the container and it wicks up into the root system continuously. In another watering technique, the roots are allowed to hang loosely in a container or enclosed space and are watered using a constant or time-metered mist (typically termed an “aeroponic” technique). Each of these techniques is characterized by enabling the roots to maintain substantial exposure to atmospheric oxygen at all or nearly all times. Notably, in each of these watering techniques a mixture of water and nutrients (this mixture being termed “nutrient water”) are applied to the roots. Such nutrients include, for example, fertilizers that transfer needed nitrogen and other vital chemical components to the plant.

Ideally, the nutrients provided to the water source would contain organic molecules, similar to those found in compost and/or soil. However, such nutrients would lead to excessive microbial activity within the water, which would harm the plant or otherwise pollute the water environment. Thus, most hydroponic systems utilize a nutrient water mixture containing alternative “man-made” chemicals, such as artificial fertilizers, to replicate the molecules found in a purely organic mixture. These fertilizer chemicals are water-soluble and do not generally create unwanted microbial activity in the water source. Such chemicals are often termed “clean” hydroponic nutrients.

One disadvantage of the use of clean nutrient water is that it is high in nitrates and other active chemicals that make it problematic to dispose of from an environmental standpoint. In addition these high concentrations tend to pollute the underlying hydroponic medium and containers making them unsuitable for repeated use.

A further, significant disadvantage of the use of “clean” hydroponic nutrients in the hydroponic water mixture is that these nutrients are not qualified by the U.S. Department of Agriculture (USDA) as “organic” and, thus, vegetables and produce grown according to such hydroponic processes can not be labeled as “organic”. While hydroponically grown produce, such as tomatoes, may be grown at a faster rate than standard organically grown tomatoes, the organically grown product may still fetch a significantly higher price premium in the marketplace. The tradeoff between speed and premium in hydroponic versus organic growth processes may still favor the organically grown product.

One way to inject “organic” nutrients into the hydroponic water has been to employ aquaculture water that is used for growing farm-bred fish. Alternatively, water that has been imbued with a “steep” of organic materials has been attempted. In the case of fish water, the organic nutrients are not sufficiently strong, as the water would otherwise be too polluted for a fish to survive. Conversely, in the case of “steeps” the water still promotes excessive microbial activity, which is undesirable. All of the above approaches have focused upon the injection of organic nutrients into the hydroponic water to attain an improved source of “organic” nutrients for hydroponically grown produce, while avoiding “clean” nutrients that abrogate the highly desired label of “organic.” It is an approach that invariably involves tradeoffs between the richness of the nutrients and their undesirable microbial-promoting effects. A system and method that voids such tradeoffs, and provides the desired level of organic nutrient content to the plant is, thus, highly desirable.

### SUMMARY OF THE INVENTION

Since the lower two-thirds (approximately) of a plant's root system are specialized to assimilate more water than oxygen and the upper one-third (approximately) are specialized to assimilate more nutrients than oxygen, this invention provides a container and associated growing process that promotes the growth of at least two different, specialized types of roots and that provides the optimal conditions for these two types of roots. In particular, the container defines an upper (or “primary”) section that promotes growth of a root ball (consisting of a fine intricate web of roots) that is surrounded by an organic, non-organic or mixed organic and non-organic nutrient-rich medium (such as a soil mixture and/or soil mixture with fertilizers/fillers). This upper section is separated by a permeable medium divider that allows predetermined quantities of water to pass into the upper section (to maintain desired moisture in the nutrient medium (soil), while a lower/bottom (or “secondary”) section contains water that may be relatively free of any nutrients (e.g. “non-nutrient” water). Extending from the upper root ball are a series of water-drinking straw-like roots that transpirate water directly from the non-nutrient lower section and that are continually exposed to massive amounts of atmospheric oxygen. A transport (capillary) device may be used to allow water to wick from the lower section into the upper section to maintain a desired level of moisture in the upper roots, and carrying with it additional dissolved oxygen via evaporation and transpiration.

In illustrative embodiments, the bottom section can be filled with an acceptable porous, water-storing medium such as gravel or rock wool. The permeable medium divider can include one or more central capillary devices that allow transfer of water from the lower reservoir into the upper section. In certain embodiments, the divider can include a series of formations that allow it to sit in an elevated manner on a water-containing structure (such as a sponge-like medium).

The container in which the upper and lower section reside, can be a unitary structure having an integral divider, or the container can be a two-part structure in which an upper section, which holds the upper root ball, is mounted atop the lower section with appropriate water transport mechanisms (e.g. capillary devices) joining the two sections so as to create a communication of water from the lower section into the root ball-containing upper section. The container structure can define a tapered shape so that the top opening is wider than the base, further facilitating evaporation of non-nutrient water from the bottom section into the upper nutrient-containing section. It is contemplated the upper and lower sections may also be watered separately, using separate sources, in a variety of ways. It is further contemplated the root system may be constructed to create additional root systems which may have organic and/or non-organic material, or processes utilized with the additional root systems. For example, a third root system could be utilized to administer other elements or processes (vibrations, etc.) to the plants roots, such as adding additional salts to the third said root system to effect change in the plant. This could minimize the effect of the additional element or process on the other root systems of the plant.

### BRIEF DESCRIPTION OF THE DRAWINGS

The invention description below refers to the accompanying drawings, of which:

FIG. 1 is a cutaway perspective view of an exemplary plant, growing within a dual root-promoting container according to an embodiment of this invention;

FIG. 2 is a side cross section of the dual root-promoting container according to an embodiment of this invention;

FIG. 3 is a side cross section of a dual root-promoting container of FIG. 2 showing a variable water level;

FIG. 4 is a side cross section of a dual root-promoting container according to another embodiment of this invention;

FIG. 5 is a side cross section of a dual root-promoting container according to another embodiment of this invention;

FIG. 6 is a side cross section of a unitary dual root-promoting container according to another embodiment of this invention;

FIG. 7 is a somewhat schematic side view of a multiple-container support base system according to an embodiment of this invention;

FIG. 8 is a somewhat schematic side view of a multiple-container support system according to another embodiment of this invention;

FIGS. 9, 10 and 11 are cutaway perspective views of container bases having a variety of capillary device formations thereon for transferring water from a base through a permeable medium;

FIG. 12 is a cutaway perspective view of a dual root-promoting container adapted for close contact between the divider and the top level of the water reservoir;

FIG. 13 is a cutaway perspective view of a dual root-promoting system having a series of conduits for directing water from the base to a top of the upper section;

FIG. 14 is a side cross section of a dual root-promoting container having a conduit for directing water from a base section to an upper section;

FIG. 15 is a cutaway perspective view of a dual root-promoting container system showing a capillary device that can be adapted to have a variety of lengths so as to accommodate a desired level of water in the base section;

FIG. 16 is a somewhat schematic cutaway view of a dual-root promoting container system using an aeroponic watering system;

FIG. 17 is a somewhat schematic cutaway view of a triple-root promoting system according to an alternate embodiment of this invention; and

FIG. 17 is a flow diagram of a process for arranging and growing plants using a dual root-promoting system.

### DETAILED DESCRIPTION OF AN ILLUSTRATIVE EMBODIMENT

A. General Considerations

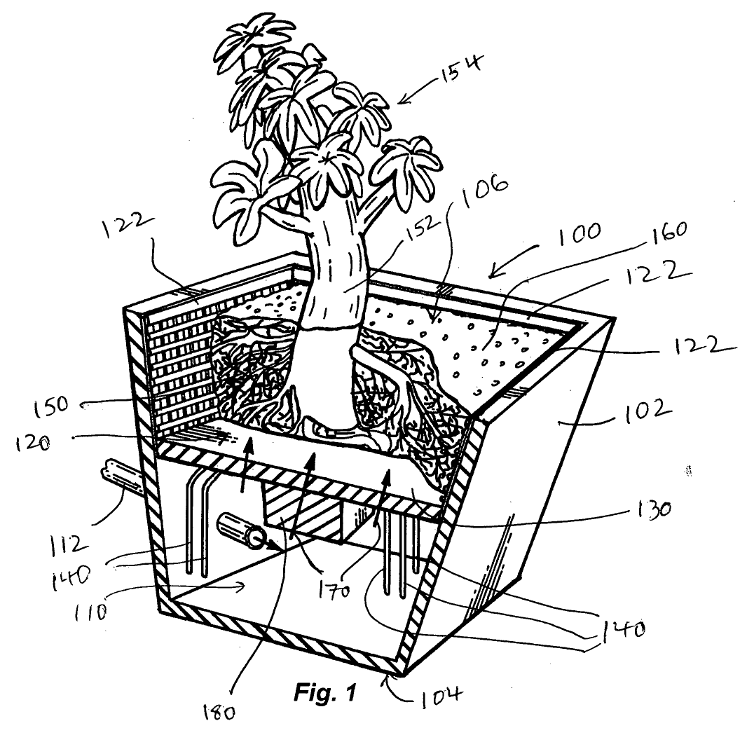

FIG. 1 shows an exemplary container system 100 used for promoting multiple (dual, in this embodiment) root systems in plants according to an illustrative embodiment of this invention. The container system 100 includes an outer container body 102 that can be any acceptable shape or size. In one example, this body is a square, tapered four-inch by four-inch box with a closed bottom side 104 and a fully open top side 106, as shown. However, the outer container can have an oblong-rectangular, ovular or circular footprint, among other shapes, in alternate embodiments. The lower (or “secondary”) section 110 of the container may be non-porous, and thereby adapted to retain non-nutrient water up to a predetermined level. As will be described below, the prevailing level of water in the lower section 110 is variable, and depends upon the overall arrangement of the container according to various embodiments described herein. By way of example, this container system 100 includes a water inlet 112 that provides water to the lower section 110 at predetermined times (ebb and flow) and/or on demand to maintain a predetermined water level (thin film or constant level). A variety of water-introduction systems can be provided to the various containers described herein. Note that the conduit 112 is shown only as an example of one type of water introduction system and that other systems for introducing water, such as applying water to the upper and lower sections using separate sources are expressly contemplated.

The top or “upper” section sub-container (generally termed “upper section container” 120 (or “primary” container) of the container system 100 is removable in this embodiment, being defined by sidewalls 122 and a bottom divider 130. The sidewalls 122 can be formed from a mesh or other porous/permeable medium, as shown, or can be solid. Notably, the divider 130 is constructed from a material that is permeable to air and moisture and may contain small perforations sufficient to allow specialized water-drawing roots to pass therethrough. As described further below, the permeable medium divider may be any substance such as a gel, or any process, such as vibrations, centrifugal force, etc., which assists the upper/primary nutrients to remain in the upper/primary section and separate from the lower/secondary roots 140 As such, the divider 130 shall be referred to generally as a “permeable medium divider” herein, or alternatively, as the “divider.” As also described generally below, the divider between sections, containing specialized root systems, is defined broadly as any material, process (e.g. dynamic or energetic barrier—as opposed to solid walls, including vibrations, centrifugal force, or the like) that allows for selective separation of elements between sections, while enabling at least certain types of roots to pass through. To this end, the divider can, for example, restrict nutrients, water, air or other elements in either direction (primary-to-secondary or secondary-to-primary) as desired by the particular parameters applied to the growth method.

As shown, the water drawing roots 140 in the lower/secondary section are shown as a series of smooth, elongated (“straw-like”) tubules that extend downwardly through the divider 130 into the bottom section non-nutrient water medium, or area. Additionally, a second intricate web-like root structure or “root ball” 150 surrounds the stem 152 of the plant 154 within the upper section container 120. This is a specialized root system 150 (e.g. a “root ball”) that consists of a web or matrix of entangled, thin, highly branched roots particularly adapted to absorb nutrients. Accordingly, the container system 100 generates a mature root structure that, in its (approximately) upper one-third consists of a highly entangles, web-like root system particularly adapted to absorb nutrients, and in its (approximately) lower two-thirds a less-branched tube-like root system, particularly adapted to draw non-nutrient water. In this embodiment, the upper container section 120 is filled with loose, permeable organic material 160, such as soil containing organic nutrients. Such organic nutrients can include a variety of acceptable substances including compost byproducts, manure and other natural fertilizers. A significant portion of the medium may, in fact, be composed of organic material, but may include mineral or inert fillers and/or other binding agents that provide further texture to the organic medium. Note also that, while an organic nutrient medium is provided to the upper section in an illustrative embodiment, a non-organic nutrient medium (e.g. containing synthetic fertilizers) or mixed organic and non-organic nutrient medium (for example biomass, fillers and fertilizer) can be provided in accordance with any of the embodiments described herein where it is appropriate to employ non-organic nutrient. The other principles for effective growth of a dual/multiple root system (to be described below) still apply to a non-organic nutrient environment.

Conversely, the non-nutrient water medium in the bottom section 110 typically contains no appreciable nutrients (except for minimal sediments from the upper section). In this manner, the non-nutrient water applied to the lower section is largely free of undesired microbial activity or other pollution-generating elements. The non-nutrient water is disposed at a maximum level that is generally no higher than the bottom of the divider 130, and in many embodiments to be described herein, is usually lower. In this manner, the tube-like roots 140 are exposed to significant quantities of atmospheric oxygen at most times.

Because the exemplary container design (100) has a larger-surface area at its widened top section than the narrowed bottom section, the container tends to facilitate the transpiration of water upwardly (arrows 170) through the divider via evaporation and capillary effects. The permeable medium divider 130 can facilitate the desired upwardly directed water transpiration into the volume of the upper container 120 as water is allowed to pass through fissures and gaps in the matrix of the divider material. The further drive the desired upward transpiration, a capillary device 180 can be employed. In this embodiment, the capillary device 180 is a downwardly projecting three-dimensional rectangle made from a material having a propensity for transporting water through small fractures and gaps into the base of the divider 130. Where such a capillary device is employed, the water may be maintained at a level that is somewhat lower than the top of the divider. This positively prevents substantial transmission of nutrients from the upper section to the lower section of the container. Since the upper section contains a soil medium that is typically drier than the pure water in the bottom section, a constant flow of water, in a metered manner, is transported into the bottom section. This flow is replenished by the conduit 112 or other water introduction mechanisms that operate continuously or periodically (e.g., watering the container). The resulting container, according to the various embodiments of this invention, effectively duplicate the natural propensity of plants to develop, in their top one-third of the root system, specialized nutrient-assimilation roots and, in the lower two-thirds, roots that specialize in water assimilation. This follows the natural world where fresh organic biomass is more often available near the top of a root system, while water is usually more available deeper in the soil, where evaporation is less pronounced.

B. Container Systems

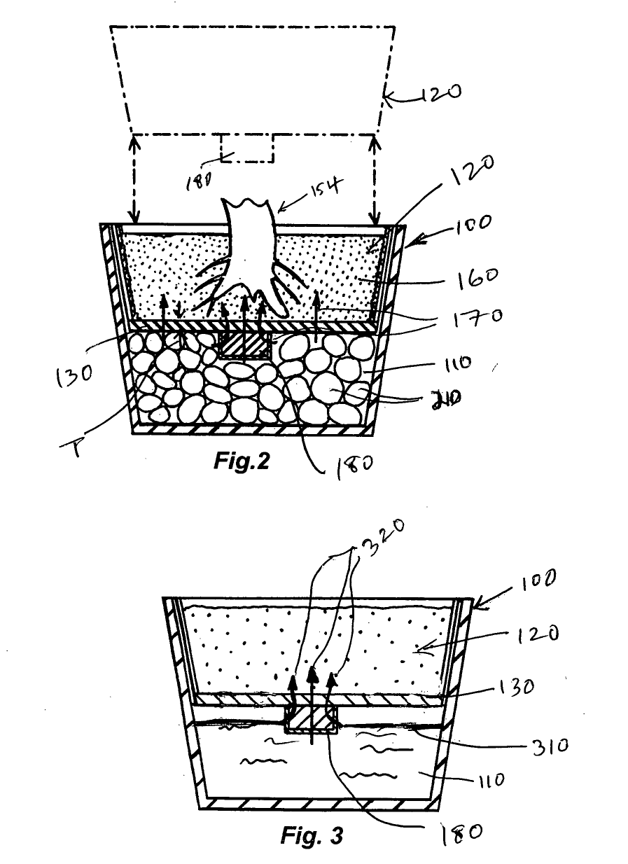

The generalized container system 100, with its removable inner container for the upper section 120 is shown further as an illustrative embodiment in FIG. 2. Note the removability of the container to a remote position, as shown in phantom. The upper container section 120 includes the above-described organic material (soil mixture) for growing a web of nutrient-absorbing roots. As shown, the capillary device 180 transports water (arrows 170) into the upper section 120 to nourish the plant 154, which is shown in its early stages of root development. Within the lower section 110, an appropriate hydroponic medium can be provided. The hydroponic medium 210, in this embodiment, comprises rock wool, perlite or lava rock/gravel, among other compounds. In general, any medium that defines interstices for retaining water and facilitating passage of tube-like roots thereinto can be used. Depending on the hydroponic medium (210) employed to fill the bottom, the capillary device 180 can vary in size. For example, where loose rock wool is used, substantial amounts of water are held in the matrix so that a smaller and thinner capillary device can be employed. Conversely, where a solid, space-filling material such as perlite or lava rock are employed, the capillary device may generally be made larger to maintain more contact with the lower moisture-content material 110.

In this example, the upper section container 120 is constructed from a wire plastic mesh with holes small enough to prevent most organic materials and soils from sifting through. In one example, approximately 12 to 18 crossed-threads per inch of mesh can be used, producing approximately 144 to 324 holes per square-inch.

The permeable medium divider 130 is constructed from a suitable porous organic or synthetic material that allows penetration of desired tube-like roots of the upper root structure downwardly (as shown in FIG. 1) into the lower section. The thickness key of the divider is highly variable. The thickness can be adjusted based upon the plants being grown and structural considerations. Depending upon the construction of the divider 130, it can, itself, act as a capillary device drawing water, through capillary action (e.g. small gaps that generate hydrostatic flow), into the upper container section 120 as a divider contacts the water or moist medium below. While a capillary device 180 of the type shown may be omitted in certain embodiments, it is generally provided for carrying further water upwardly into the upper section 120 to ensure that the volume of the upper section 120 remains sufficiently moist to maintain healthy roots and allow uptake of nutrients via continued nutrient-rich fluid flow into the upper root system 150.

One or more capillary devices can be employed in a given container, as will be described below. The capillary device can be constructed from any water-transmitting material such as wool, peat moss, plastic, clay or another device (e.g., a small diameter pipe or tube) that allows water to be drawn upwardly through capillary action from a moist region into a less-moist region. As shown in FIG. 3, the capillary device 180 can be a simple structure mounted on the bottom of the permeable medium divider 130 that sits within the water (e.g., below the water line 310) in a lower section 110. In this manner, where the water level 310 falls below the bottom of the permeable medium divider 130, the capillary device 180 continues to transport water (arrows 320) into the upper section 120. It should be noted that the capillary device, permeable divider 130 and upper section container 120 can be made as a single unit in a plurality of shapes and sizes or as a multi-section unit using a multiplicity of appropriate materials. Such materials should enable water permeation, but retain sufficient structural integrity to function properly in a moist environment for at least the projected growing time of the subject plant. Accordingly the upper section container 120 can be formed or molded from a variety of materials, including organic peat moss, coconut fiber, clay, plastic or another porous synthetic material.

In accordance with FIGS. 2 and 3, the outer container 102 can be considered a typical hydroponic or solid-walled plant container. The upper section container 120 in this embodiment is adapted to fit appropriately within that outer container 102. The upper section container 120 can be mounted in, and removed from, the outer container 102 as shown in phantom in FIG. 2.

Note that while the upper section container 120 herein is shown as conforming closely to the inner walls of the outer container 102, it is expressly contemplated that it may sit within a larger-inner-opening container using appropriate brackets, hooks, legs or supports (not shown). In addition, where the outer container is tapered, it is contemplated that the inner container may not define a conforming taper, but that the two containers are still adapted to seat together in an appropriate arrangement allowing communication of water between the upper and lower sections thereof. In other words the upper container engages the inner walls of the outer container at some point so that it is supported above, and in fluid-communication with, the lower section.

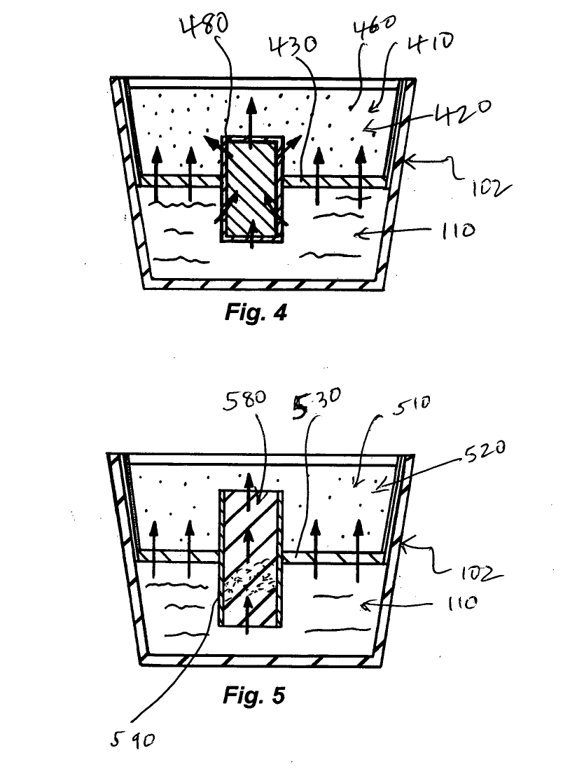

With reference to FIG. 4, an alternate embodiment of the upper section container 410 is shown nested within the exemplary outer container 102. This upper section container 410 includes an appropriately sized permeable medium divider 430 and a capillary device 480 that extends upwardly into the volume of the upper section 420. Water is transmitted through the capillary device from the lower section 110. An additional area within the volume of the upper section 420 assists in more evenly watering the upper section and ensuring that water is delivered deep into the volume of the nutrient material 460. The structure of the capillary device can be formed from any acceptable material as described above. It can, thus, be molded as a unitary member with divider and other sections of the container 410, or it can be provided separately as an attached unit passing through an orifice in the divider 430. To this end, it can be variable in size and shape and can be positioned laterally (upwardly) and downwardly to achieve the appropriate projection into the volume of the upper section 420.

With reference to FIG. 5, an upper section container 510 having a divider 530 as described above, is shown. This container includes a capillary tube or another structure 580 having a relatively open orifice or lumen that transmits water between the lower section 110 and volume of the upper section 520. The tube can be constructed of one or more small diameter passageways or can include a wicking material 590 that assist in transporting water from the lower section 110 into the volume of the upper section 520.

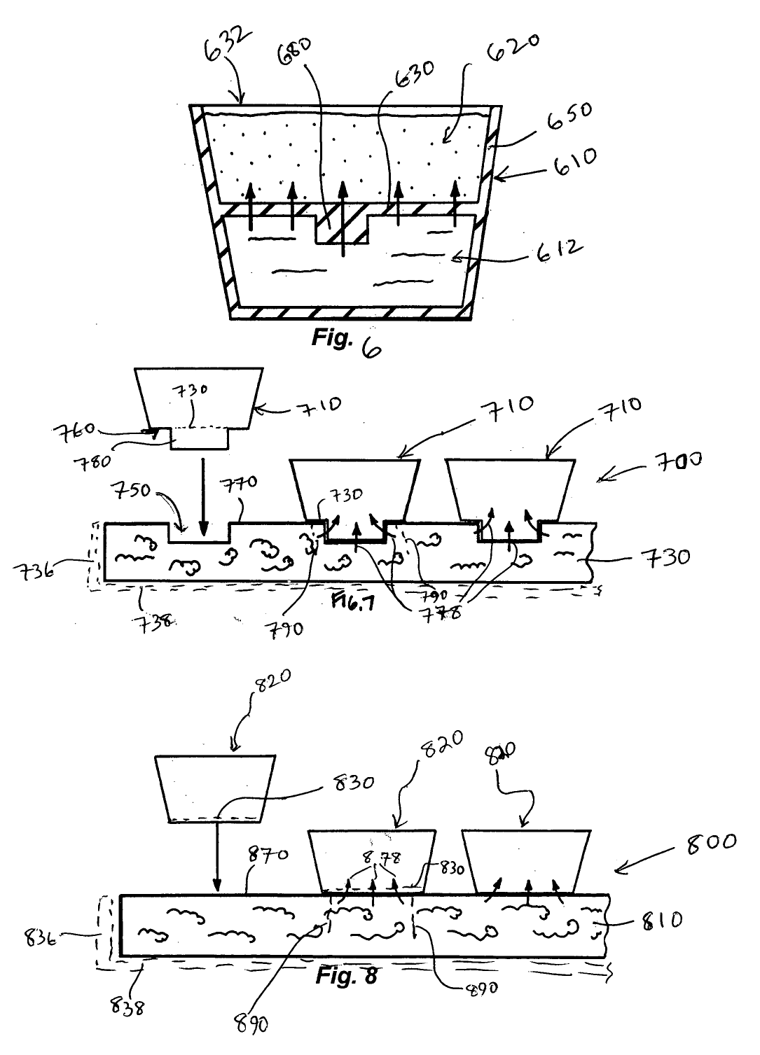

While the above-described embodiments typically provide a separate upper section container, FIG. 6 shows a unitary container 610 wherein the lower/bottom section 612 holds non-nutrient water and is separated from the upper nutrient-carrying section 620 by a permeable medium divider 630 having a structure described generally above. An appropriate capillary device 680 can also be provided. The lower section 612 is provided with water through a side-mounted water introduction conduit (not shown but described as exemplary element 112 above) or any other method, which may be described herein and as well, other methods are contemplated. The overall container can be constructed from a variety of materials. The outer walls 650 may be watertight at least up to the level of the divider 630 to prevent loss of water from the lower non-nutrient section. However, the outer walls and bottom may also be made of any capillary material or porous material. The divider 630 is porous, thereby allowing non-nutrient water to permeate upwardly therethrough, and preventing nutrient material from passing downwardly into the lower section 612. It is contemplated that any of the containers, dividers, or capillary devices described herein can be implemented as part of a single, unitary container structure as shown generally in FIG. 6.

FIG. 7 shows a container-watering and mounting system 700 in which one or more removable upper section containers 710 are mounted on top of a non-nutrient watering medium 730. In this embodiment, the medium is a water-retaining material such as rock wool (although other water-retaining/storing materials are expressly contemplated). It can include outer walls 736 (shown in phantom) and an interconnected base 738 (also shown in phantom) that collectively prevent water from escaping the rock wool matrix, and also retain the edges of the rock wool within a desired form and shape. The rock wool can include a series of channels 750 sized and arranged to receive a base 760 of a container having an appropriate permeable medium divider 730 and a capillary device 780. In this embodiment, the channel 750 is sized particularly to receive the capillary device 780, while the outlying areas of the base 760 remain at rest on the top section 770 of the rock wool medium 730. When seated in a channel 750, the container transpires water thereinto (arrows 778) while moisture/oxygen-loving tubular roots 790 pass through the divider 730 and into the lower hydroponic medium. In FIGS. 7 and 8 the permeable medium divider may be constructed to allow the root growth from the upper/primary section to pass to the lower/secondary section while not allowing the passage of other elements such as water, nutrients, air, etc. from either the lower/secondary section to the upper/primary section, or from the upper/primary section to the lower/secondary section. In this instance, the divider can be constructed from a gel or waxy substance, or similar material, which resists water passage, but allows roots to pass through. Alternatively, the divider can resist passage of water and other flowing materials using, for example, vibration (or other dynamic/energy-inputting processes), so as to form a dynamic barrier that blocks fluid passage but permits root passage. In this case, the separate sections could be watered using separate methods or sources.

Upper/primary roots and lower/secondary roots may be configured in any percentages relative to each other, and not strictly upper ⅓ and lower ⅔rds. Furthermore, while not shown, it is expressly contemplated that the two (or more) root sections of the container can be oriented in a geometry different than the upper/lower (vertical) geometry generally described. Rather, in an alternate embodiment, the sections can be positioned horizontally (side-by-side) with a permeable medium divider that permits root passage therethrough between the side-by-side sections. As such, the terms “upper” and “lower” sections can be substituted herein with the terms “primary” and “secondary” or “first” and “second” sections. Moreover, upper/primary roots and lower/secondary roots are not always configured one above the other, and may be arranged side by side, or any other configuration such as a sphere with primary roots in the center of the sphere with secondary roots surrounding or adjacent to the primary roots, such as may be used in an outer space environment.

A similar container-mounting and watering system is shown in FIG. 8. In this embodiment, a watering medium 810 constructed from a mineral material such as perlite (other materials being expressly contemplated), is provided as a base for upper section containers 820. In this embodiment, no capillary device is employed, rather, the permeable medium divider 830 rests directly on the top surface 870 of the perlite medium 810. Direct, full surface contact between the watering medium and the divider are provided. The divider 830 allows water-loving roots 890 to pass therethrough and into the perlite, while water transpires (arrows 878) upwardly into each container 820 by evaporation or capillary action as described above. The perlite medium 810 can be encased in a water tight wall 836 and floor 838 structure, similar to that described above with reference to FIG. 7.

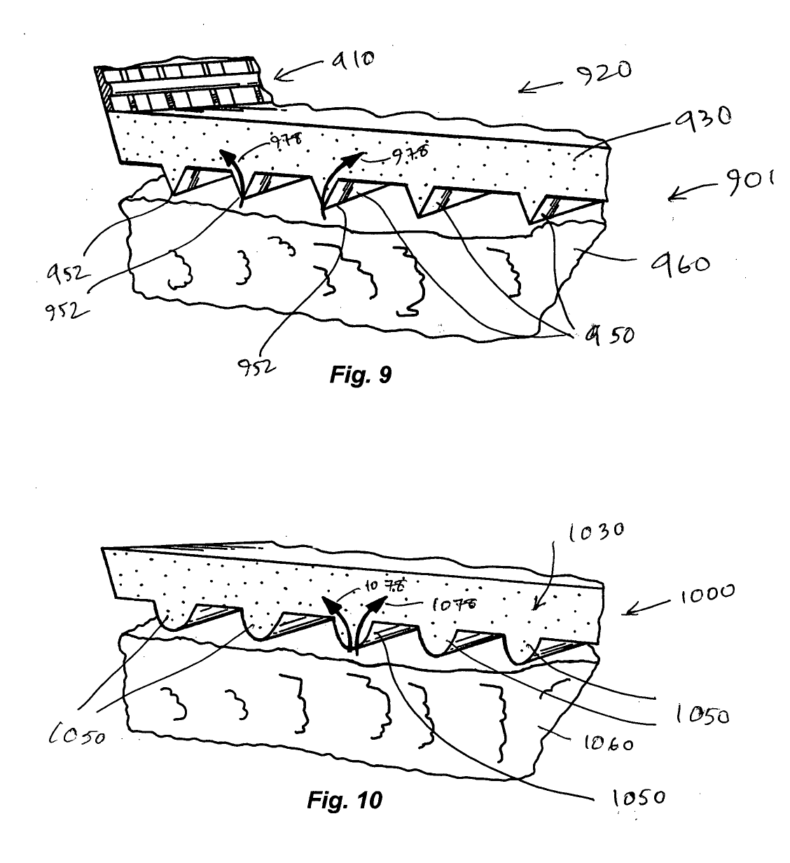

For use with the above-described container-mounting and watering mediums 730 or 810, the associated container's permeable medium divider can be provided with a variety of structures to facilitate transport of water into the container and prevent return of water from the container into the medium (730, 810). Accordingly, FIG. 9 shows an upper container structure 900 in which the permeable medium divider 930 of the container 910 includes a series of inverted triangular-cross section ridges 950. The ridges 950 sit with their apices 952 on the surface of the medium 960. The apices 952 draw surrounding water from the medium 960 (arrows 978), and whence into the divider 930. The divider, in turn feeds this drawn water into the nutrient-medium-containing volume 920 of the container 910. Once moisture is passed through the ridges 950, it is largely barred from draining back into the medium as it disperses out into the volume.

A further container support system 1000 is shown in FIG. 10. The ridges 1050 in this embodiment have a somewhat semi-circular or semi-ovular cross section. This structure also provides desirable, directional passage (arrows 1078) of moisture from the medium 1060 into and through the divider 1030. Transport of water may occur at a somewhat higher volume due to a larger area of surface contact between the medium 1060 and the ridges 1050.

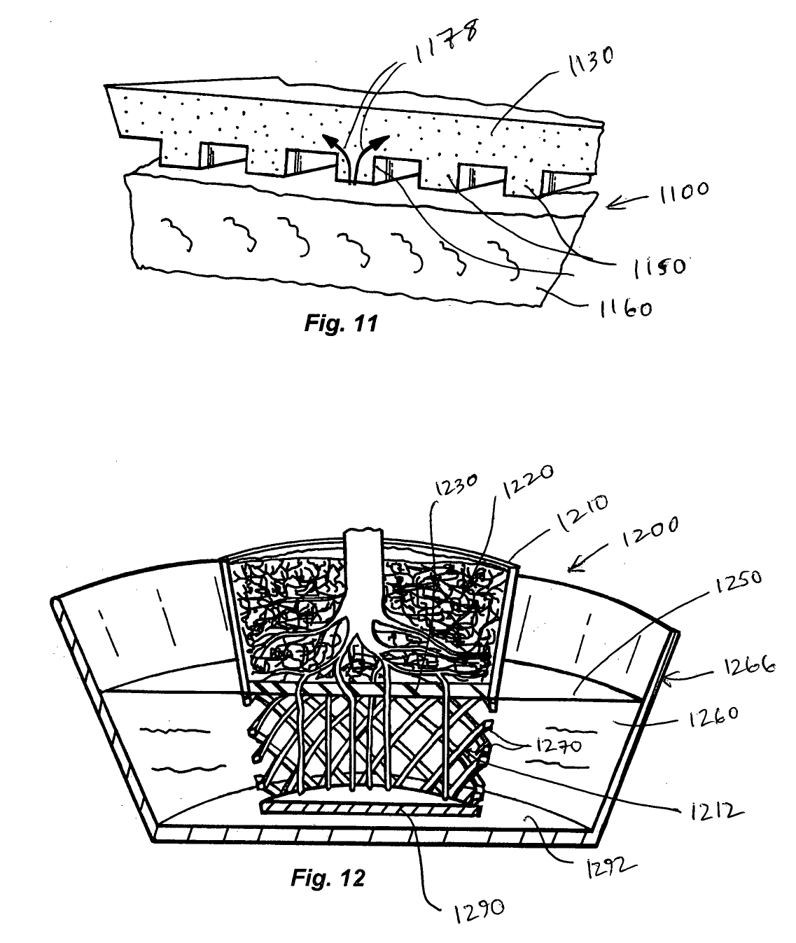

Likewise, the support system 1100 of FIG. 11 utilizes ridges 1150 that define rectangular or square cross sections and that, again, facilitate largely one way movement (arrows 1178) of moisture from the medium 1160 through the divider 1130.

A variety of container-support structures, which elevate the majority of the permeable medium divider 1130 off the surface of the water-storing medium, can be employed in various alternate embodiments. These support structures can be continuously formed across the bottom of the divider, or can be broken in a variety of ways.

Note that an added advantage of using ridges to elevate the divider off of the surface of the water-storing medium, as shown, is that it provides more free airflow to the root system. The ridges or other elevating structures can be constructed as a unitary member with the bottom of the divider, or can be attached to the divider as separate components. They can be constructed of the same material as the divider or from a different material having enhanced capillary action. While not shown, the ridge bottom structure, as defined in any of the above embodiments, can be supplemented with one or more capillary devices (as described variously herein) located along the bottom surface of the divider.

FIG. 12 shows a container system 1200 in which a unitary (e.g. single-piece/single-material-molded construction) container body 1210 is employed. This container includes an upper section 1220 for housing the nutrient material that grows an intricate root ball, as shown, while a divider 1230 that is constructed as a separate plate-like insert, or as part of the overall container 1210, rests at or near the water line 1250 of a reservoir or pool 1266 of non-nutrient water 1260. The lower/bottom section 1212 of the container is constructed from open mesh or other porous structure 1270 that allows water from a larger surrounding area 1260 to flow freely into and out of the bottom section 1212. A base 1290 can be provided at the lowermost end of the container 1210 to support it on the bottom surface 1292 of the pool 1266. The container can be constructed from a variety of materials, typically having sufficient structural integrity so as to function properly during prolonged exposure to a moist environment, as shown.

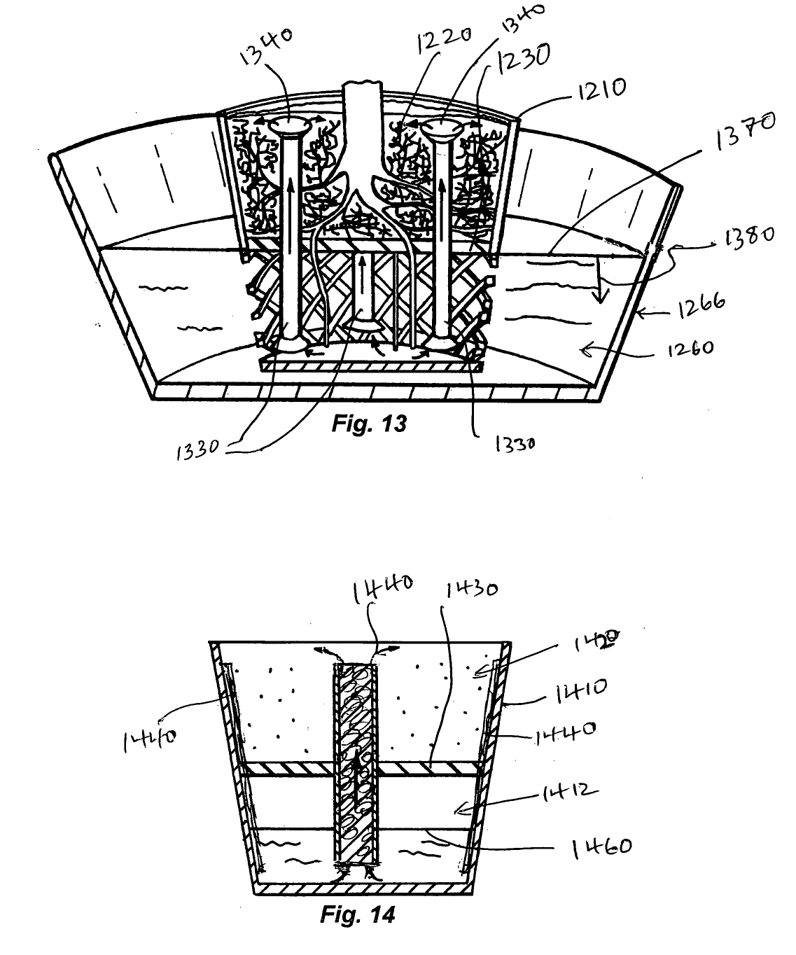

The unitary container 1210 can be provided with appropriate capillary devices, as shown in FIG. 13. In this embodiment, the capillary devices comprise one or more capillary tubes 1330 having small-diameter lumens that direct water from the water source 1260 deeply into the upper section 1220 of the container 1210 (e.g. near the top end). The outlets 1340 of the capillary tubes 1330 can be located variably so as to provide the appropriate level of water to the volume of the upper section 1220. The tube outlets 1340 can be located all at a similar level within the upper volume (as shown), or the outlets 1340 can be located at different levels in alternate embodiments to direct water variously to differing levels of the volume. The inner diameter of the capillary tubes (e.g. the lumen diameter) is chosen to provide an appropriate level of water transfer through capillary action. Each tubes' lumen can be hollow or can include various fillers (e.g. cotton, rock wool, minerals—not shown) to facilitate transport of water through a wicking action. In this embodiment (and others) the water level 1370 can vary (arrow 1380) over time between the (approximately) maximum fill level as shown (just adjacent to the permeable medium divider 1230) and a lower level that is still within the draw of the tubes 1330. The capillary tubes may be positioned so that they maintain appropriate fluid communication between the upper volume and the prevailing lower section through a larger range of water levels, thus ensuring a continuous supply of moisture to the nutrient-containing upper medium.

FIG. 14 shows a container 1410 formed as a unitary member with an integral or unitary divider 1430. The upper section 1420 receives water from the lower section 1412 using one or more wicks 1440. Wicks can be constructed from a variety of materials (rock wool, cotton, rag, peat moss, various fibers, clay, porous plastic, etc.), and may define a variety of shapes and/or sizes. In this embodiment, the wicks 1440 can be located along the interior of the volume or along the sidewalls, as shown. They pass through the permeable medium divider 1430, and thereby allow water to be transported from the lower section 1460 that may be remote from the divider 1430 into the divider matrix and also directly into the volume of the upper section 1420. As defined herein, the wicks can also be generally termed “capillary devices.”

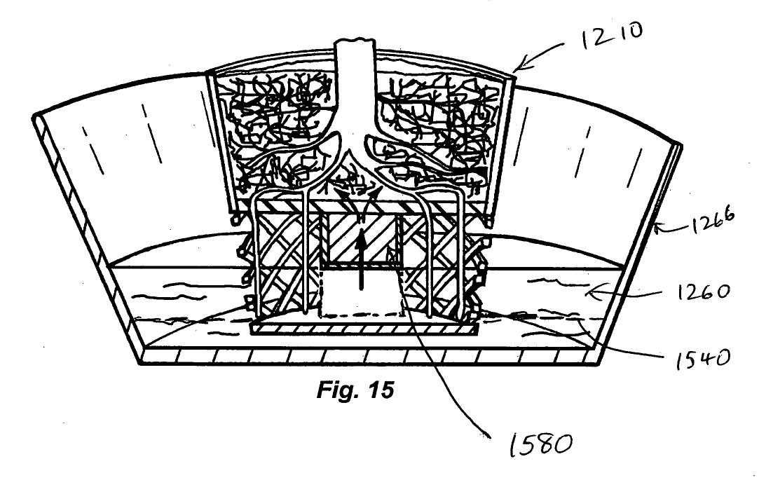

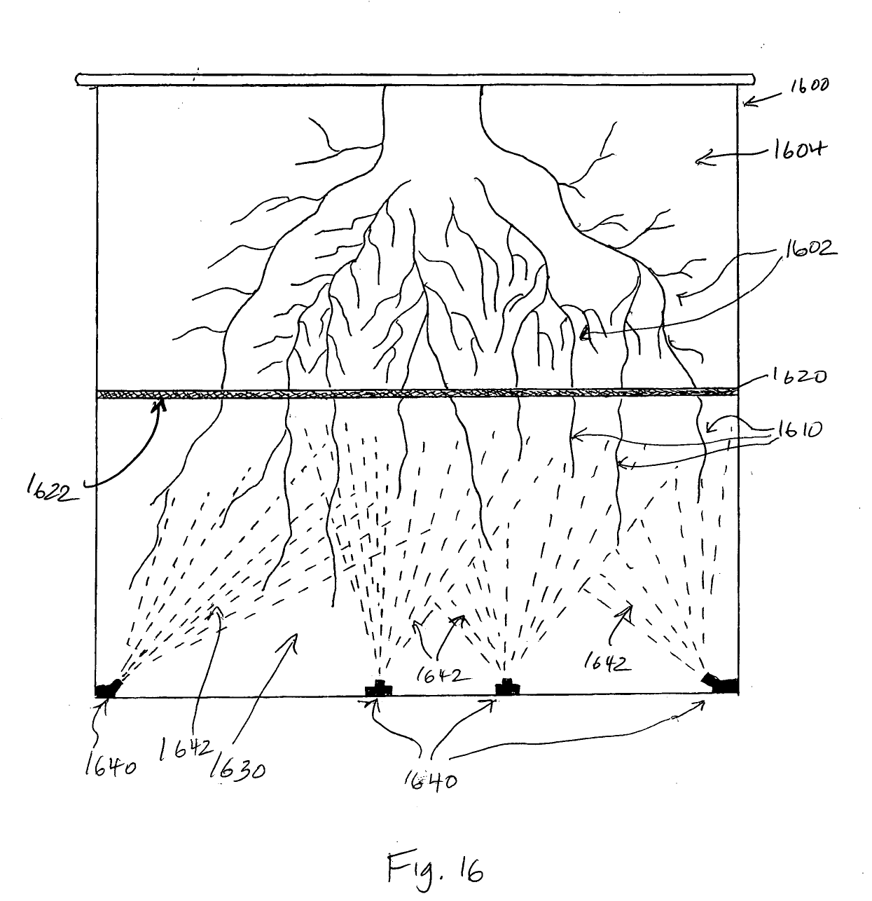

FIG. 15 shows a system that employs the unitary container 1210, as described above, seated in a water source 1260. The capillary device 1580 can be sized shorter (shown in solid line) or longer (shown in phantom). When shorter, the capillary device 1580 can be used in conjunction with a large amount of non-nutrient water in the lower section 1260. Such a large amount may be used in a traditional hydroponic ebb and flow method. Conversely, the longer capillary device 1580 (phantom) is employed when only a film of non-nutrient water is applied to the lower section using, for example, a non-nutrient film (see water level 1540, shown in phantom) flow technique.

Having described particular arrangements for delivering non-nutrient water to the lower root section and upper root ball, it should be noted that this invention a variety of different techniques for delivering non-nutrient water to the system. By way of further background, in hydroponic growing water is often stored in a “reservoir.” The water may be stored in a large container under the hydroponic setup, or at a distant location. The place where the dual rooting containers of the various embodiments of this invention are placed, is usually termed the “grow bed.” The containers are positioned in the grow bed and water is then pumped from the reservoir to the grow bed. The water in the grow bed may be periodically raised to a certain level such as with the ebb and flow method. Alternatively, when the dual-root-promoting container is placed on the floor of the grow bed, a thin film of water is flowed past the bottom of the container. Likewise, in an aeroponic setup the lower roots hang into an empty grow bed, and are misted using water from a reservoir. FIG. 16 shows such an alternate setup in which the techniques of this invention are employed in conjunction with aeroponic watering.

In FIG. 16, the upper web or roots 1602 is formed within the nutrient medium upper section 1604 of the dual-root-promoting container 1600. Appropriate lower root tubules 1610 penetrate the permeable medium divider 1620 to hang in an airspace 1630 for maximum aeration at all times. At predetermined intervals, the aeroponic nozzles 1640 apply a fine mist 1642 of non-nutrient water to the lower roots 1610. This mist is sufficient in volume and duration-of-application to maintain appropriate moisture in the plant, and also to maintain desired moisture content in the permeable medium divider 1620 (via direct application of mist water to the bottom surface 1622 and also through upward evaporation from the lower airspace 1630). This aeroponic technique can be used in conjunction with other watering techniques and/or any of the containers described herein.

It should be clear that any other appropriate hydroponic watering technique can also be employed to deliver non-nutrient water to the plant in a dual/multiple-root-promoting container according to an embodiment of this invention.

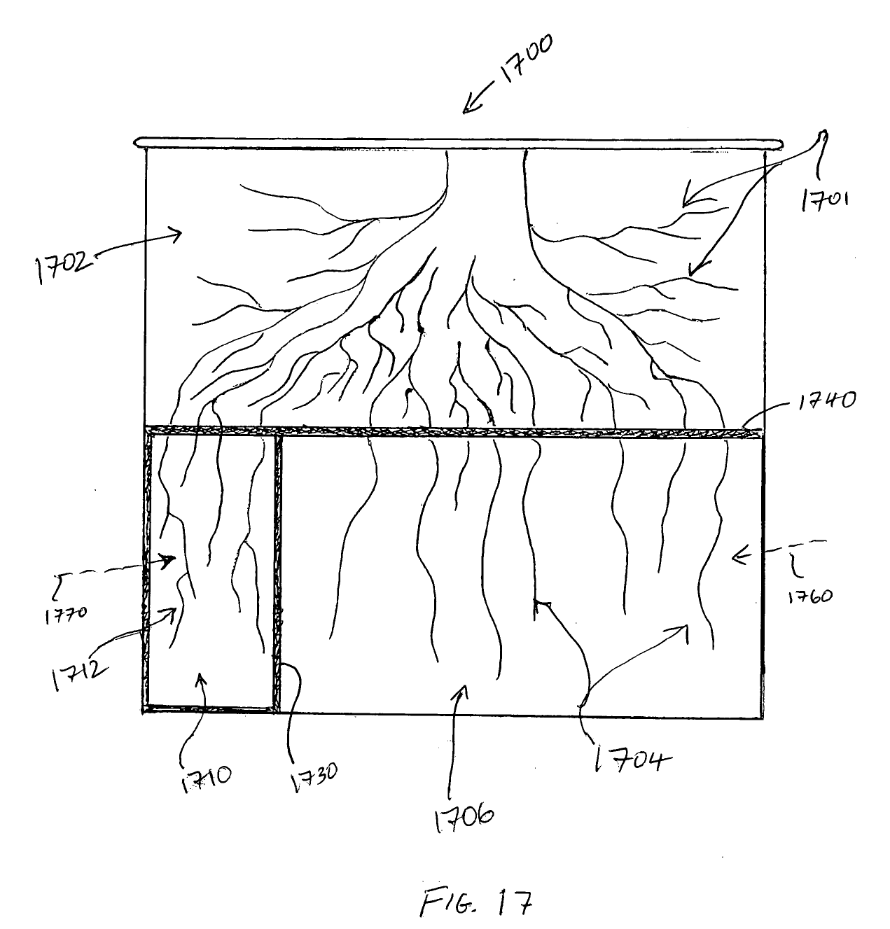

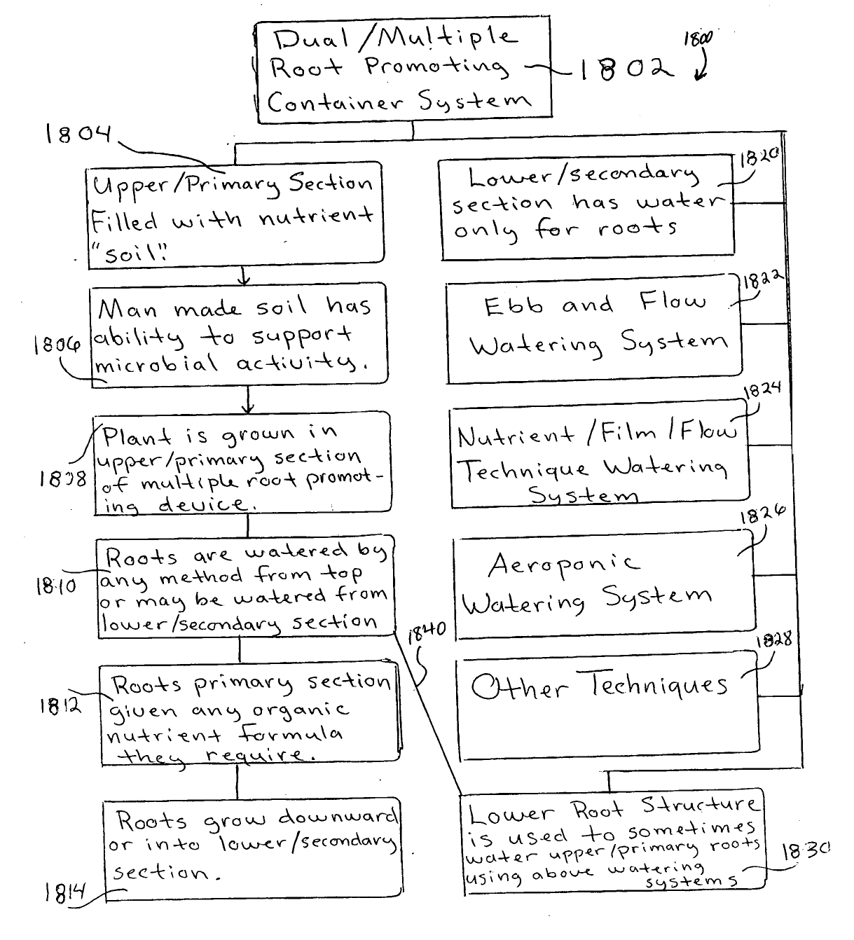

As shown in FIG. 17, it is further contemplated that the overall system 1700 may be constructed to create additional root systems in addition to the root system 1701 of the upper/primary section 1702 and the root system 1704 of the lower/secondary section 1706. This additional or “tertiary” section 1710 may include a root system 1712 fed by organic or non-organic nutrient material, and/or may utilize additional processes for growth and nutrition of the plant. For example, a tertiary root system 1712 could be utilized to administer other elements or processes (vibrations, etc.) to the plant's roots, such as adding additional salts to the third root system to effect change in the plant (such effecting of change also herein defined as “manipulation of plant processes”). By way of example, adding salts of various types may be desirable in the growth of tomatoes in order to sweeten their taste. This could minimize the effect of the additional element or process on the other root systems (primary and secondary) of the plant. To this end, a non-permeable (solid) barrier 1730 is provided in the lower section area (1706) that segregates the tertiary section 1710 from the remaining lower section 1706 along a horizontal (side-by-side) arrangement. The divider 1740 stands above the secondary and tertiary sections and allows roots from the primary root ball 1701 to extend into each section 1706 and 1710, while the roots and elements are prevented from passing between the two lower sections 1706 and 1710 by the divider 1730. Water and other elements are provided separately to each of the lower sections 1706 and 1710 through a variety of introduction techniques (described herein), represented generally by dashed arrows 1760 and 1770, respectively.

Note that two sections 1706 and 1710 are provided in a side-by-side arrangement in this embodiment. In alternate embodiments, a permeable medium divider can be substituted for the solid divider 1730, allowing roots to pass sideways (horizontally) between side-by-side sections.

C. Dual Root-Promoting Growth Process

Having described various embodiments of a container system for promoting multiple root growth, a generalized procedure for growing plants in a manner that promotes multiple (or dual) root growth is described FIG. 18. The process 1800 has as a goal, the growth of multiple roots using one of the container systems described generally herein (block 1802). Referring first to upper section activity, the grower fills the upper section with nutrient medium or “soil” (block 1804). This soil has the ability to support microbial activity (block 1806), being part of a preferred organic mixture for feeding the plant its needed nutrients. Plant seeds, seedlings, clones, etc. are placed in the soil section in a soil-containing upper section (block 1808). The roots in that section are usually watered through passage of water (via capillary action, etc.) from the lower section using a variety of techniques described above including capillary tubes, transfer of water through permeable dividers, etc. but may be watered using a separate source other than the lower section (block 1810). During plant-growth, the developing web of nutrient-loving roots in the upper section can be fed any supplemental organic formula (e.g. compost, manure, etc.) that is needed for proper growth (block 1812). It is assumed that the dividers in the upper section will prevent this material from passing into the lower section. Over time, the roots in the upper section form the desired intricate web or root ball, while straw-like, water-loving feeder roots pass through the divider into the lower section (block 1814). These feeder roots are exposed to tremendous amounts of atmospheric oxygen as described herein.

With reference to concurrent bottom-section activity in the process 1800, the grower applies water to the lower section through a variety of techniques (block 1820). These techniques (each described generally above) can include a conventional ebb and flow watering system (block 1822). Nutrient film technique watering system (block 1824) where the water is, in fact, a non-nutrient water, but provided in a film according to conventional watering techniques. Similarly, watering can be provided by a conventional aeroponic watering system (block 1826). Likewise, other conventional and novel techniques (block 1828) can be employed to maintain sufficient water within the system. Using these watering techniques, the bottom root structure is continuously/periodically watered (block 18730), and this water is transferred in appropriate amounts (procedure branch 1840) to the upper root ball via capillary devices and the permeable divider.

Water may also be applied to the upper and lower sections from separate sources. The upper section may use standard non-organic nutrients, in a hydroponic medium, while the bottom section receives non-nutrient water, thus allowing standard hydroponics methods to be combined with the dual-root-system-aspects of this invention.

The foregoing has been a detailed description of illustrative embodiments of this invention. Various modifications and additions can be made without departing from the spirit and scope thereof. For example, multi-section and unitary containers having various combinations of features described herein can be employed. Any of the containers described herein can have any one of the water transfer devices (capillary devices, etc.) or other water delivery mechanisms described herein. Additionally, as discussed, dividers between sections can be side-by-side or concentric (spheres, etc.), include increased selectivity as to passage of elements and can restrict passage of such elements in one and/or both directions. Thus, this description should not be limited to the particular embodiments shown, but the reader should assume that each of the features can be combined in various ways with other features herein to produce the desired system. Accordingly, this description is meant to be taken only by way of example and not to otherwise limit the scope of the invention.

1. A multiple root-promoting system comprising:
a primary section having a nutrient medium;
a secondary section having non-nutrient water; and
a divider between the primary section and the secondary section, the divider adapted to allow passage of roots therethrough, but substantially preventing the nutrient medium from passing therethrough.

2. The system as set forth in claim 1 wherein the nutrient medium includes non-organic nutrients.

3. The system as set forth in claim 1 wherein the nutrient medium comprises an organic nutrient medium.

4. The system as set forth in claim 3 wherein the permeable divider includes at least one capillary device extending into the non-nutrient water and transporting the non-nutrient water through the divider and into the primary section.

5. The system as set forth in claim 4 wherein the capillary device comprises a structure formed from a water transporting material.

6. The system as set forth in claim 4 wherein the capillary device comprises at least one capillary tube.

7. The system as set forth in claim 4 wherein the capillary device comprises at least one wick.

8. The system as set forth in claim 1 wherein each part of the divider, the primary section and secondary section, are formed as part of a unitary container.

9. The system as set forth in claim 8 wherein the unitary container includes at least one of either a porous floor or wall about the secondary section for allowing non-nutrient water from an outer non-nutrient water source to pass thereinto.

10. The system as set forth in claim 4 wherein the capillary device comprises a structure that is variously sized so as to either one of (a) have a shortened length that receives the non-nutrient water according to an ebb and flow watering technique, and (b) have a longer length constructed and arranged to receive the non-nutrient water from a thin film.

11. The system as set forth in claim 1 wherein the divider is constructed and arranged to allow passage of the non-nutrient water from the secondary section to the primary section.

12. The system as set forth in claim 11 wherein the lower section comprises a water-storing medium upon which the divider is disposed.

13. The system as set forth in claim 12 wherein the water storing medium comprises rock wool and the divider includes a capillary device that projects downwardly from the divider into the rock wool.

14. The system as set forth in claim 12 wherein the medium comprises perlite and wherein the divider is adapted to be disposed in contact with the top surface of the perlite thereof.

15. The system as set forth in claim 14 wherein the divider includes a plurality of ridged structures for transferring the non-nutrient water from the perlite to the divider.

16. The system as set forth in claim 11 wherein the primary section is constructed from walls defined by at least one of a synthetic mesh, peat moss, or coconut fiber.

17. The system as set forth in claim 1 wherein the primary section is an upper section and the secondary section is a lower section located in a vertical orientation beneath the upper section.

18. The system as set forth in claim 17 wherein the upper section is adapted to seat against inner walls of an outer container that houses the lower section.

19. The system as set forth in claim 18 wherein the upper section and the lower section together define a tapering structure having a greater surface area at an upper end than a surface area at a lower end.

20. The system as set forth in claim 1 wherein the primary section and the secondary section are each constructed and arranged to receive the non-nutrient water from an aeroponic watering mechanism.

21. The system as set forth in claim 1 wherein the primary section and the secondary section are each constructed and arranged to receive the non-nutrient water based upon a predetermined hydroponic watering technique.

22. The system as set forth in claim 1 wherein the divider is constructed and arranged to allow the passage of roots from the primary section to the secondary section while restricting passage of elements including, at least, water, nutrients and air between the primary section and the secondary section.

23. The system as set forth in claim 22 wherein the divider comprises one of at least a gel material, a waxy material and a dynamic or energetic process.

24. The system as set forth in claim 1 further comprising a tertiary section located adjacent to at least part of the divider that allows roots to pass therethrough while restricting passage of nutrients and water.

25. The system as set forth in claim 24 wherein the tertiary section includes roots that receive at least one of (a) predetermined specialized elements (b) processes for promoting plant growth, and (c) manipulation of plant processes.

26. The system as set forth in claim 25 wherein the predetermined elements include a salt.

27. The system as set forth in claim 24 wherein the tertiary section is located horizontally, side-by-side with respect to the secondary section and wherein each of the secondary section and the tertiary section are beneath the divider, the secondary section and the tertiary section being separated by a solid non-permeable divider.

28. A method for promoting multiple roots in a hydroponic environment comprising:
providing a nutrient medium to a primary section of a container;
locating a divider between the primary section of the container and a secondary section having non-nutrient water therein, the divider allowing roots to pass from the primary section to the secondary section, but substantially preventing the nutrient from passing into the secondary section; and
providing a capillary device to transport the non-nutrient water from the secondary section in predetermined amounts to the primary section.

29. The method as set forth in claim 28 wherein the step of providing the nutrient medium includes providing one of either an organic nutrient medium and a non-organic nutrient medium.

30. A method for promoting multiple roots in a hydroponic environment comprising:
providing a first location for growth of a first root system type that receives nutrients;
providing a second location for growth of a second root system type that receives non-nutrient water and that is exposed directly to air; and
positioning a divider between the first location and the second location so as to allow the second type of roots to extend through the divider while restricting passage of predetermined elements between the first location and the second location.

31. The method as set forth in claim 30 further comprising providing a third location for segregating predetermined roots from the second root type and applying at least one of at least one of (a) predetermined specialized elements (b) processes for promoting plant growth, and (c) manipulation of plant processes.

32. The method as set forth in claim 30 further comprising transporting the non-nutrient water through the divider from the second location to the first location to moisten the first location.

33. The method as set forth in claim 32 wherein the step of transporting includes forming the divider at least in part from a material that is permeable to the non-nutrient water.

34. The method as set forth in claim 32 wherein the step of transporting includes providing a capillary device in communication with the divider that contacts the non-nutrient water in the second location and predetermined parts of the first location.
